(19) United States
(12) Patent Application Publication
(10) Pub. No.: US 2003/0236378 A1
(43) Pub. Date: Dec. 25, 2003

(54) For producing propylene polymers that are suited for fiber spinning

(76) Inventors: Diana Ozdemir, Bensheim (DE); Michael Schuster, Mannheim (DE); Franz Langhauser, Ruppertsberg (DE); J?uuml;rgen Schwind, Bornheim (DE); J?uuml;rgen Suhm, Worms-Weinsheim (DE); David Fischer, Breunigweiler (DE)

Correspondence Address: CONNOLLY BOVE LODGE & HUTZ, LLP, P O BOX 2207, WILMINGTON, DE, 19899, US

(21) Appl. No.: 10/296,422

(22) PCT Filed: May 29, 2001
(86) PCT No.: PCT/EP01/06108

(30) Foreign Application Priority Data
May 30, 2000 (DE) 100 26 579.0

(51) Int. Cl. C08F 110/00

(52) U.S. Cl. 526/348.1; 526/351; 526/170; 526/943

(57) ABSTRACT

A process for producing from propylene, ethylene and/or C₄-C₁₈-alk-1-enes a fiber grade propylene polymer in which not less than 90 mol % of the units derived from monomers are derived from propylene and which has a polydispersity index PDI of not more than 2.2, where PDI is M_{W}/M_{N}, where M_{W} is the weight average molar mass and MN is the number average molar mass and both are determined by gel permeation chromatography (GPC) at 145° C. in 1,2,4-trichlorobenzene, by polymerizing the monomers by means of a metallocene catalyst system, comprises subsequently degrading said propylene polymer peroxidically or thermally.

The propylene polymers obtainable thereby are useful for producing films and moldings as well as fibers.

The present invention relates to processes for producing from propylene, ethylene and/or C₄-C₁₈-alk-1-enes a fiber grade propylene polymer in which not less than 90 mol % of the units derived from monomers are derived from propylene and which has a polydispersity index PDI of not more than 2.2, where PDI is M_{W}/M_{N}, by polymerizing the monomers by means of a metallocene catalyst system. The present invention further relates to propylene polymers obtainable by these processes, to a process for producing various such propylene polymers which differ in their melt flow rate, to the use of the propylene polymers for producing fiber, and also to film, fiber and shaped articles comprising said propylene polymers.

Propylene polymers are widely used for producing fibers, filaments or nonwoven fabrics. A feature common to these applications is that the propylene polymers used are in each case first melted, for example in an extruder, and then spun through a spinneret.

As regards the spinning of propylene polymers, it is common knowledge that the spinnability, the structure and the properties of the fibers depend on the width of the molar mass distribution of the propylene polymers used. F. Kloos, Kunststoffe 77, 1987, 1168 -1172 and S. Misra, F.-M. Lu, J. E. Spruiell and G. C. Richeson, J. Appl. Polym. Sci. 56, 1995, 1761-1779 observed that increasing narrowness of the molar mass distribution improves the spinnability and increases the fiber strength. A further significant factor is the average molar mass or flowability of the polymers.

A customary way of converting propylene polymers having broad molar mass distributions into propylene polymers having a narrowed molar mass distribution is to subject the polymers to a thermal or peroxidic degradation process, which also has the effect of reducing the average molar mass.

Narrow molar mass distributions are also obtained on producing the propylene polymers by metallocene-catalyzed polymerization. Accordingly, EP-A 600 461 and WO 94/28219, for example, describe fiber grade propylene polymers which were obtained by means of metallocene catalysts. These polymers have the advantage of good spinnability and of being processable into fibers possessing high strength. In addition, they make it possiible to obtain low denier fibers and their atactic fractions and also the residues from the catalysts, especially corrosive halogens, are less.

EP-A 985 686 describes propylene polymer molding compositions obtained by reaction of a crystalline propylene polymer and of a peroxide. The reaction reduces the width of the molar mass distribution to from 75% to 95% of the value of the starting material. The crystalline propylene polymers used for producing these propylene polymer molding compositions have a polydispersity index of more than 2.8.

Although the strength of the fibers produced from these propylene polymers, obtained by metallocene catalysts, is distinctly higher than on using conventional polypropylenes, there continues to be a need for propylene polymers from which it is possible to spin fibers of even higher strength.

It is an object of the present invention to eliminate the shortcomings described and to provide propylene polymers that possess good spinnability and have low atactic fractions and low residues especially of halogens and that are spinnable into fibers of further increased strength.

We have found that this object is achieved by a process for producing from propylene, ethylene and/or C₄-C₁₈-alk-1-enes a fiber grade propylene polymer in which not less than 90 mol % of the units derived from monomers are derived from propylene and which has a polydispersity index PDI of not more than 2.2, where PDI is M_{W}/M_{N}, where M_{W} is the weight average molar mass and M_{N} is the number average molar mass and both are determined by gel permeation chromatography (GPC) at 145° C. in 1,2,4-trichlorobenzene, by polymerizing the monomers by means of a metallocene catalyst system, which comprises subsequently degrading said propylene polymer peroxidically or thermally. This is because it has been found that, for the same polymer melt flow rate (MFR), fiber strength can be further increased by subjecting the propylene polymers obtained using metallocene catalysts to a peroxidic or thermal degradation step, even though this does not further change the width of the molar mass distribution. In addition, the economics are improved, since different products having different melt flow rates can be produced from the same product of the polymerization reaction. This invention further provides propylene polymers obtainable by this process, a process for producing various such propylene polymers which differ in their melt flow rate, a method of using the propylene polymers to produce fibers, and films, fibers and shaped articles comprising the propylene polymers.

The process of the invention produces fiber grade propylene polymers by polymerization of propylene, ethylene and/or C₄-C₁₈-alk-1-enes. By C₄-C₁₈-alk-1-enes are meant linear or branched 1-alkenes of from four to eighteen carbon atoms. Linear 1-alkenes are preferred. Ethylene, 1-butene, 1-pentene, 1-hexene, 1-heptene or 1-octene or mixtures thereof are suitable in particular, and preference is given to using ethylene or 1-butene. The propylene polymers contain not less than 90 mol % of units derived from propylene. The level of units derived from propylene is preferably not less than 95 mol %, especially not less than 98 mol %. Particular preference is given to using propylene as the sole monomer in the process of the invention, i.e. the fiber grade propylene polymers are propylene homopolymers.

By metallocene catalysts are meant all catalyst systems that contain at least one metallocene compound. Metallocenes are all complexes of metals of transition groups of the periodic table of the elements with organic ligands that combine with compounds that form metallocenium ions to form effective catalyst systems.

Metallocene catalyst systems useful for the invention generally include as active constituents

A) at least one metallocene complex of the general formula (I)

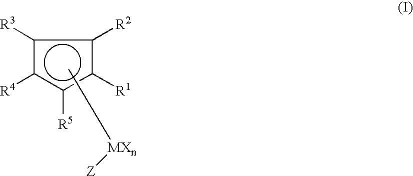

where

M is titanium, zirconium, hafnium, vanadium, niobium or tantalum or an element of group III of the periodic table or a lanthanide,

X is fluorine, chlorine, bromine, iodine, hydrogen, C₁-C₁₀-alkyl, C₆-C₁₅-aryl, alkylaryl having from 1 to 10 carbon atoms in the alkyl radical and from 6 to 20 carbon atoms in the aryl radical, —OR⁶ or NR⁶R⁷,

n is 1, 2 or 3, where n is the valence of M minus 2,

where

R⁶ and R⁷ are each C₁-C₁₀-alkyl, C₆-C₁₅-aryl, alkylaryl, arylalkyl, fluoroalkyl or fluoroaryl each having from 1 to 10 carbon atoms in the alkyl radical and from 6 to 20 carbon atoms in the aryl radical and

the radicals X are identical or different,

R¹ to R⁵ are each hydrogen, C₁-C₁₀-alkyl, 5- to 7-membered cycloalkyl which may in turn bear a C₁-C₁₀-alkyl group as substituent, C₆-C₁₅-aryl or arylalkyl, where two adjacent radicals may also together form saturated or unsaturated cyclic groups having from 4 to 15 carbon atoms, or Si(R⁸)₃ where

R⁸ can be C₁-C₁₀-alkyl, C₃-C₁₀-cycloalkyl or C₆-C₁₅-aryl, and

z is X or

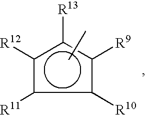

where the radicals

R⁹ to R¹³ are each hydrogen, C₁-C₁₀-alkyl, 5- to 7-membered cycloalkyl which may in turn bear a C₁-C₁₀-alkyl group as substituent, C₆-C₁₅-aryl or arylalkyl, where two adjacent radicals may also together form saturated or unsaturated cyclic groups having from 4 to 15 carbon atoms, or Si(R¹⁴)₃ where

R¹⁴ is C₁-C₁₀-alkyl, C₃-C₁₀-cycloalkyl or C₆-C₁₅-aryl,

or the radicals R⁴ and Z together form an —R¹⁵—A—group in which

R¹⁵

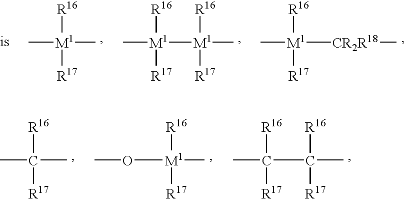

═BR¹⁶, ═AlR¹⁶, —Ge—, —Sn—, —O—, —S—, ═SO, ═SO₂, ═NR¹⁶, ═CO, ═PR¹⁶ or ═P(O)R¹⁶,

where

R¹⁶, R¹⁷ and R¹⁸ are identical or different and are each a hydrogen atom, a halogen atom, a C₁-C₁₀-alkyl group, a C₁-C₁₀-fluoroalkyl group, a C₆-C₁₀-fluoroaryl group, a C₆-C₁₀-aryl group, a C₁-C₁₀-alkoxy group, a C₂-C₁₀-alkenyl group, a C₇-C₄₀-arylalkyl group, a C₈-C₄₀-arylalkenyl group or a C₇-C₄₀-alkylaryl group, or two adjacent radicals together with the atoms connecting them form a saturated or unsaturated ring having from 4 to 15 carbon atoms, and

M¹ is silicon, germanium or tin,

A is —O—, —S—,

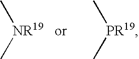

where

R¹⁹ is C₁-C₁₀-alkyl, C₆-C₁₅-aryl, C₃-C₁₀-cycloalkyl, C₇-C₁₈-alkylaryl or Si(R²⁰)₃,

R²⁰ is hydrogen, C₁-C₁₀-alkyl, C₆-C₁₅-aryl which may in turn bear C₁-C₄-alkyl groups as substituents or C₃-C₁₀-cycloalkyl,

or the radicals R⁴ and R¹² together form an —R¹⁵—group.

The radicals X in the general formula (I) are preferably identical.

Among the metallocene complexes of the general formula (I), preference is given to

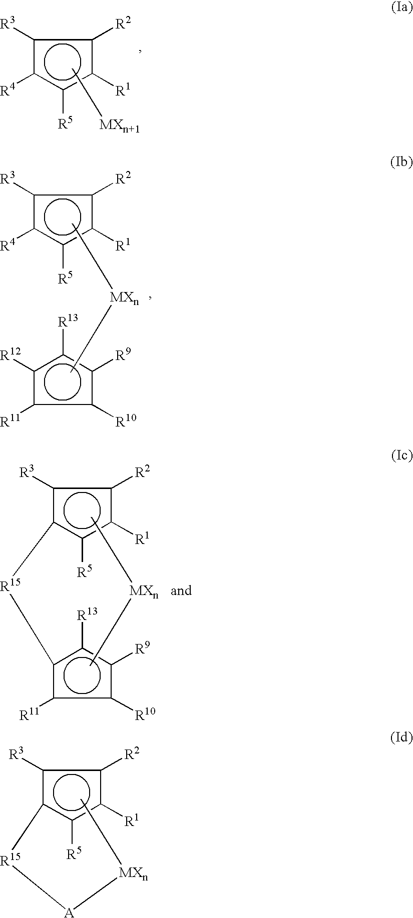

Among the compounds of the formula (Ia), particular preference is given to those in which

M is titanium, zirconium or hafnium,

x is chlorine, C₁-C₄-alkyl or phenyl,

n is 2 and

R¹ to R⁵ are each hydrogen or C₁-C₄-alkyl.

Among the compounds of the formula (Ib), preference is given to those in which

M is titanium, zirconium or hafnium,

x is chlorine, C₁-C₄-alkyl or phenyl,

n is 2,

R¹ to R⁵ are each hydrogen, C₁-C₄-alkyl or Si(R⁸)₃ and

R⁹ to R¹³ are each hydrogen, C₁-C₄-alkyl or Si(R¹⁴)₃.

Particularly useful compounds of the formula (Ib) are those in which the cyclopentadienyl radicals are identical.

Examples of particularly useful compounds are:

bis (cyclopentadienyl) zirconium dichloride,

bis (pentamethylcyclopentadienyl) zirconium dichloride,

bis (methylcyclopentadienyl) zirconium dichloride,

bis (ethylcyclopentadienyl) zirconium dichloride,

bis (n-butylcyclopentadienyl) zirconium dichloride and

bis (trimethylsilylcyclopentadienyl) zirconium dichloride

and also the corresponding dimethyl zirconium compounds.

Particularly useful compounds of the formula (Ic) are those in which

R¹ and R⁹ are identical and are each hydrogen or C₁-C₁₀-alkyl,

R⁵ and R¹³ are identical and are each hydrogen or a methyl, ethyl, isopropyl or tert-butyl group,

R³ and R¹¹ are each C₁-C₄-alkyl and

R² and R¹⁰ are each hydrogen

or

two adjacent radicals R² and R³ or R¹⁰ and R¹¹ together form saturated or unsaturated cyclic groups having from 4 to 12 carbon atoms,

R¹⁵ is

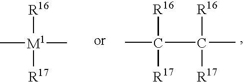

M is titanium, zirconium or hafnium and

x is chlorine, C₁-C₄-alkyl or phenyl.

Examples of particularly useful complexes (Ic) are

dimethylsilanediylbis (cyclopentadienyl) zirconium dichloride,

dimethylsilanediylbis (indenyl) zirconium dichloride,

dimethylsilanediylbis (tetrahydroindenyl) zirconium dichloride,

ethylenebis (cyclopentadienyl) zirconium dichloride,

ethylenebis (indenyl) zirconium dichloride,

ethylenebis (tetrahydroindenyl) zirconium dichloride,

tetramethylethylene-9-fluorenylcyclopentadienyl zirconium dichloride,

dimethylsilanediylbis (3-tert-butyl-5-methylcyclopentadienyl)-zirconium dichloride,

dimethylsilanediylbis (3-tert-butyl-5-ethylcyclopentadienyl)-zirconium dichloride,

dimethylsilanediylbis (2-methylindenyl) zirconium dichloride,

dimethylsilanediylbis (2-isopropylindenyl) zirconium dichloride,

dimethylsilanediylbis (2-tert-butylindenyl) zirconium dichloride,

diethylsilanediylbis (2-methylindenyl) zirconium dibromide,

dimethylsilanediylbis (3-methyl-5-methylcyclopentadienyl)-zirconium dichloride,

dimethylsilanediylbis (3-ethyl-5-isopropylcyclopentadienyl)-zirconium dichloride,

dimethylsilanediylbis (2-ethylindenyl) zirconium dichloride,

dimethylsilanediylbis (2-methyl-4,5-benzindenyl) zirconium dichloride,

dimethylsilanediylbis (2-ethyl-4,5-benzindenyl) zirconium dichloride,

methylphenylsilanediylbis (2-methyl-4,5-benzindenyl) zirconium dichloride,

methylphenylsilanediylbis (2-ethyl-4,5-benzindenyl) zirconium dichloride,

diphenylsilanediylbis (2-methyl-4,5-benzindenyl) zirconium dichloride,

diphenylsilanediylbis (2-ethyl-4,5-benzindenyl) zirconium dichloride and diphenylsilanediylbis (2-methylindenyl) hafnium dichloride

and also the corresponding dimethylzirconium compounds.

Further examples of suitable complexes are

dimethylsilanediylbis (2-methyl-4-phenylindenyl) zirconium dichloride,

dimethylsilanediylbis (2-methyl-4-naphthylindenyl) zirconium dichloride,

dimethylsilanediylbis (2-methyl-4-isopropylindenyl) zirconium dichloride,

dimethylsilanediylbis (2-methyl-4,6-diisopropylindenyl) zirconium dichloride,

dimethylsilanediylbis (2-methyl-4-[4′-tert-butylphenyl]indenyl)-zirconium dichloride,

dimethylsilanediylbis (2-ethyl-4-[4′-tert-butylphenyl]indenyl)-zirconium dichloride,

dimethylsilanediylbis (2-propyl-4-[4′-tert-butylphenyl]indenyl)-zirconium dichloride and

dimethylsilanediyl(2-isopropyl-4-[4′-tert-butylphenyl]indenyl)-(2-methyl-4-[4′-tert-butylphenyl]indenyl) Zirconium dichloride

and also the corresponding dimethylzirconium compounds.

Particularly useful compounds of the general formula (Id) are those in which

M is titanium or zirconium,

X is chlorine, C₁-C₄-alkyl or phenyl,

R¹⁵ is

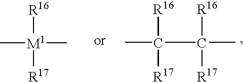

A is —O—, —S—,

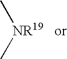

and

R¹ to R³ and R⁵ are each hydrogen, C₁-C₁₀-alkyl, C₃-C₁₀-cycloalkyl, C₆-C₁₅-aryl or Si(R⁸)₃, or two adjacent radicals form cyclic groups having from 4 to 12 carbon atoms.

The synthesis of such complexes can be carried out by methods known per se, preferably by reacting the appropriately substituted, cyclic hydrocarbon anions with halides of titanium, zirconium, hafnium, vanadium, niobium or tantalum.

Examples of appropriate preparative methods are described, for example, in Journal of Organometallic Chemistry, 369 (1989), 359-370.

Component A) may also be a mixture of various metallocene complexes.

The metallocene catalyst systems further include as component B) at least one compound capable of forming metallocenium ions.

Suitable compounds B) capable of forming metallocenium ions are, for example, strong, uncharged Lewis acids, ionic compounds having Lewis-acid cations or ionic compounds having Brbnsted acids as cations.

As strong, uncharged Lewis acids, preference is given to compounds of the general formula (II)

M²X¹X²X³ (II)

where

M² is an element of group 13 of the periodic table, in particular B, Al or Ga, preferably B,

X¹, X² and X³ are each hydrogen, C₁-C₁₀-alkyl, C₆-C₁₅-aryl, alkylaryl, arylalkyl, haloalkyl or haloaryl each having from 1 to 10 carbon atoms in the alkyl radical and from 6 to 20 carbon atoms in the aryl radical or fluorine, chlorine, bromine or iodine, in particular haloaryls, preferably pentafluorophenyl.

Particular preference is given to compounds of the general formula (II) in which X¹, X² and X³ are identical, preferably tris (pentafluorophenyl) borane.

Suitable ionic compounds having Lewis-acid cations are compounds of the general formula (III)

[(Y^{a+})Q₁Q₂ . . . Q_{z}]^{d+} (III)

where

Y is an element of groups 1 to 14 of the periodic table,

Q₁ to Q_{z} are singly negatively charged groups such as C₁-C₂₈-alkyl, C₆-C₁₅-aryl, alkylaryl, arylalkyl, haloalkyl, haloaryl each having from 6 to 20 carbon atoms in the aryl radical and from 1 to 28 carbon atoms in the alkyl radical, C₃-C₁₀-cycloalkyl which may bear C₁-C₁₀-alkyl groups as substituents, halogen, C₁-C₂₈-alkoxy, C₆-C₁₅-aryloxy, silyl or mercaptyl groups,

a is an integer from 1 to 6 and

z is an integer from 0 to 5,

d is the difference a-z, but is greater than or equal to 1.

Particularly useful Lewis-acid cations are carbonium cations, oxonium cations and sulfonium cations and also cationic transition metal complexes. Particular mention may be made of the triphenylmethyl cation, the silver cation and the 1,1′-dimethylferrocenyl cation. They preferably have noncoordinating counterions, in particular boron compounds as are also mentioned in WO 91/09882, preferably tetrakis (pentafluorophenyl) borate.

Ionic compounds having Brönsted acids as cations and preferably likewise noncoordinating counterions are mentioned in WO 91/09882; the preferred cation is N,N-dimethylanilinium.

The amount of strong, uncharged Lewis acids, ionic compounds having Lewis-acid cations or ionic compounds having Brbnsted acids as cations is preferably from 0.1 to 10 equivalents, based on the metallocene complex A).

Particularly useful compounds B) capable of forming metallocenium ions are open-chain or cyclic aluminoxane compounds of the general formula (IV) or (V)

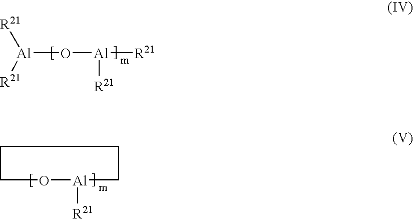

where R²¹ is a C₁-C₄-alkyl group, preferably a methyl or ethyl group, and m is an integer from 5 to 30, preferably from 10 to 25.

The preparation of these oligomeric aluminoxane compounds is usually carried out by reacting a solution of trialkylaluminum with water and is described, for example, in EP-A 284 708 and U.S. Pat. No. 4,794,096.

The oligomeric aluminoxane compounds obtained in this way are generally in the form of mixtures of both linear and cyclic chain molecules of various lengths, so that m should be regarded as a mean. The aluminoxane compounds can also be present in admixture with other metal alkyls, preferably with aluminum alkyls.

It has been found to be advantageous to use the metallocene complexes A) and the oligomeric aluminoxane compounds of the general formulae (IV) and (V) in such amounts that the atomic ratio of aluminum from the oligomeric aluminoxane compounds to the transition metal from the metallocene complexes is in the range from 10:1 to 10⁶:1, in particular from 10:1 to 10⁴:1.

In place of the aluminoxane compounds of the general formulae (IV) and (V), it is also possible to use aryloxyaluminoxanes as described in U.S. Pat. No. 5,391,793, aminoaluminoxanes as described in U.S. Pat. No. 5,371,260, aminoaluminoxane hydrochlorides as described in EP-A 633 264, siloxyaluminoxanes as described in EP-A 621 279 or mixtures thereof as component B).

Useful metallocenium ion formers B) also include the boron aluminum compounds disclosed in WO 99/06414 such as, for example, di[bis(pentafluorophenylboroxy)]methylalane. The boron aluminum compounds may also be used deposited on an organic or inorganic carrier or support.

Both the metallocene complexes A) and the compounds B) capable of forming metallocenium ions are preferably used in solution, particularly preferably in aromatic hydrocarbons having from 6 to 20 carbon atoms, in particular xylene and toluene.

Useful metallocene catalyst systems can further comprise, as additional component C), a metal compound of the general formula (VI)

M³(R²²)ᵣ(R²³)ₛ(R²⁴)ₜ (VI)

where

M³ is an alkali metal, an alkaline earth metal or a metal of group 13 of the periodic table, i.e. boron, aluminum, gallium, indium or thallium,

R²² is hydrogen, C₁-C₁₀-alkyl, C₆-C₁₅-aryl, alkylaryl or arylalkyl each having from 1 to 10 carbon atoms in the alkyl radical and from 6 to 20 carbon atoms in the aryl radical,

R²³ and R²⁴ are each hydrogen, halogen, C₁-C₁₀-alkyl, C₆-C₁₅-aryl, alkylaryl, arylalkyl or alkoxy each having from 1 to 10 carbon atoms in the alkyl radical and from 6 to 20 carbon atoms in the aryl radical,

r is an integer from 1 to 3

and

s and t are integers from 0 to 2, where the sum r+s+t corresponds to the valence of M³.

Among the metal compounds of the general formula (VI), preference is given to those in which

M³ is lithium, magnesium or aluminum and

R²³ and R²⁴ are each C₁-C₁₀-alkyl.

Particularly preferred metal compounds of the formula (VI) are n-butyllithium, n-butyl-n-octylmagnesium, n-butyl-n-heptylmagnesium, tri-n-hexylaluminum, tri-iso-butylaluminum, triethylaluminum and trimethylaluminum.

When a metal compound C) is used, it is preferably present in the catalyst system in such an amount that the molar ratio of M³ from formula (VI) to transition metal M from formula (I) is from 800:1 to 1:1, in particular from 500:1 to 50:1.

The metallocene complexes A) may also be used on a carrier or support material.

Support materials used are preferably finely divided supports, which generally have a particle diameter in the range from 1 to 300 μm, especially in the range from 20 to 90 μm. Useful support materials include for example inorganic oxides of silicon, of aluminum, of titanium or of one of the metals of main group I or II of the periodic table or mixtures thereof, of which apart from alumina or magnesia or a sheet silicate preference is given in particular to silica gel.

The support may be subjected to a thermal treatment, for example to remove adsorbed water, in which case such a treatment is generally carried out in the range from 80 to 200° C., preferably in the range from 100 to 150° C., or the support may be calcined. The support may also be given a chemical treatment, in which case customary driers such as metal alkyls, preferably aluminum alkyls, chlorosilanes or SiCl₄ are used.

Useful supports further include finely divided polyolefins, for example finely divided polypropylene.

The metallocene catalyst systems may also be mixed with Ziegler catalysts, in the presence or absence of any of the monomers to be polymerized, and used in the olefin polymerization.

It is also possible, for example in suspension or bulk procedures, for the catalysts to have been prepolymerized or preactivated.

The polymerization may be carried out in a known manner in bulk, in suspension or in the gas phase in the customary reactors used for the polymerization of propylene, either batchwise or preferably continuously, in one or more stages. Generally the polymerization is carried out at from 20 to 150° C. and from 1 to 100 bar using average residence times of from 0.5 to 5 hours.

Preference is given to temperatures in the range from 60 to 90° C., pressures in the range from 20 to 35 bar and average residence times in the range from 0.5 to 3 hours.

The polymers obtained in the polymerization of the process according to the invention have a molar mass distribution with a polydispersity index PDI=M_{W}/M_{N} of not more than 2.2, preferably not more than 2.0, the molar mass distribution being determined by gel permeation chromatography (GPC) in 1,2,4-trichlorobenzene at 145° C. using polypropylene standards having molar masses of from 100 to 10⁷ g/mol to calibrate the GPC.

The peroxidic or thermal degradation of the propylene polymers is generally carried out in extruders or mixers, customarily on the polymer in the as-polymerized form. Any single- or two-stage machine can be used that accepts solid or liquid molding compositions and extrudes same, predominantly continuously, through an orifice. Examples of extruders are Diskpack plasticators, pin-type extruders and planetary extruders. Other possibilities are combinations of mixers with discharge screws and/or gear pumps. Preferred extruders are screw extruders, and these may be constructed as single- or twin-screw machines. Particular preference is given to twin-screw extruders and continuous mixers with discharge elements. Machinery of this type is conventional in the plastics industry and is manufactured by, for example, Werner & Pfleiderer, Berstorff, Leistritz, JSW, Farrel, Kobe or Toshiba.

To degrade the propylene polymers peroxidically, they are contacted with a peroxide. Customary peroxides are dicumyl peroxide, bis-(tert-butylperoxyisopropyl) benzene, 2,5-dimethyl-2,5-di-tert-butylperoxyhexane and di-tert-butyl peroxide. The peroxide used is preferably 2,5-dimethyl-2,5-di-tert-butylperoxyhexane. The amount of peroxide used is generally in the range from 0.1 to 2 kg per metric ton of polypropylene.

The reaction of propylene polymers with the peroxide is generally effected at extruder temperatures in the range from 180 to 280° C., preferably from 190 to 260° C. The pressures prevailing in the extruder are in the range from 0 to 200 bar, preferably from 0.5 to 150 bar.

No peroxide is added when the propylene polymers are to be degraded thermally. However, the extrusion is then customarily carried out at extruder temperatures in the range from 190 to 300° C., preferably from 210 to 280° C.

Degradation increases the flowability of the melt of the propylene polymers used according to the invention without significant effects on the width of the molar mass distribution.

The fiber grade propylene polymers obtained in the process according to the invention have a post-degradation flowability (determined as ISO 1133 melt flow rate MFR at 230° C. under a weight of 2.16 kg) in the range from 4 to 3000 g/10 min, especially in the range from 8 to 40 g/10 min. The melt temperatures of the fiber grade propylene polymers (determined by DSC according to ISO 3146) are generally in the range from 120 to 165° C., preferably in the range from 145 to 155° C.

In general, the fiber grade propylene polymers are additized with customary additives such as stabilizers, lubricants, demolding agents, fillers, nucleating agents, antistats, plasticizers, dyes, pigments or flame retardants in customary amounts. In general, the additives are added straight away, in the course of the extrusion step that brings about the degradation.

Customary stabilizers are antioxidants such as sterically hindered phenols, processing stabilizers such as phosphites or phosphonites, acid traps such as calcium stearate, zinc stearate or dihydrotalcite, sterically hindered amines, or else UV stabilizers. Generally the propylene polymer composition of the invention includes one or more of the stabilizers in amounts of up to 2% by weight

Useful lubricants and demolding agents include for example fatty acids, calcium or zinc salts of fatty acids, fatty amides or low molecular weight polyolefin waxes, which are customarily used in concentrations of up to 2% by weight.

Useful fillers for the propylene polymer composition include for example talc, chalk or glass fibers in amounts of up to 50% by weight.

Useful nucleating agents include for example inorganic additives such as talc, silica or kaolin, salts of mono- or polycarboxylic acids such as sodium benzoate or aluminum tert-butylbenzoate, dibenzylidene sorbitol or its C₁-C₈-alkyl-substituted derivatives such as methyl- or dimethyldibenzylidene sorbitol or salts of diesters of phosphoric acid such as sodium 2,2′-methylenebis-(4,6-di-tert-butylphenyl) phosphate. The nucleating agent content of the propylene polymer composition is generally up to 5% by weight.

Additives of this type are generally commercially available and are described for example in Gächter/Müller, Plastics Additives Handbook, 4th Edition, Hansa Publishers, Munich, 1993.

A particularly preferred process for producing different propylene polymers according to the invention which have different MFR melt flow rates comprises controlling the metallocene-catalyzed polymerization of the monomers in such a way, for example by adding a molar mass regulator such as hydrogen, that the polymerization provides substantially always the same melt flow rate and the differences in the melt flow rates of the degraded products are obtained by adding different amounts of peroxide. This has the advantage in the case of large industrial-scale continuous processes that it is not necessary to change the conditions in the reactor, and then to await the establishment of an equilibrium state, when switching from one product to the next. On the contrary, it is merely necessary to change the amount of peroxide added, for example in the extruder. This makes it possible to change between two on-spec products produced according to the invention within a very short time and with a very small amount of off-spec transition material. This makes the overall process very economical.

The propylene polymers produced by the process according to the invention are notable for low levels of atactic fractions and for low residues, especially with regard to halogens, are producible in a particularly economical manner and have good spinning properties, providing fibers of very high strength.

The invention further provides the fibers, filaments and webs produced from the polymers.

The fibers, filaments and webs can be produced by a wide variety of customary processing technologies. It is possible, for example, to produce nonwoven webs by Reifenhäuser's reicofil technology. Continuous filament yarns (CF/BCF/POY) are obtainable for example through Barmag or Neumag technologies. Staple fiber can be produced for example using lines from Fare.

The fibers, filaments and webs produced from the propylene polymers obtained according to the invention are particularly outstanding in strength.

### Examples

The samples were characterized using the following tests:

Determination of the melt flow rate (MFR):

according to ISO standard 1133, at 230° C. under a weight of 2.16 kg

Gel permeation chromatography (GPC):

GPC was carried out at 145° C. in 1,2,4-trichlorobenzene using a 150C GPC apparatus from Waters. The data were analyzed using the Win-GPC software from HS-Entwicklungsgesellschaft für wissenschaftliche Hard-und Software mbH, Ober-Hilbersheim. The columns were calibrated by means of polypropylene standards having molar masses of from 100 to 10⁷ g/mol.

The weight average molar masses (M_{w}) and number average molar masses (Mₙ) of the polymers were determined. The PDI is the ratio of the weight average molar mass (M_{w}) to the number average molar mass (Mₙ).

Determination of fiber tenacity:

According to ISO standard 2062 EN using a Tensorapid 3 measuring instrument.

Determination of fiber extension:

According to DIN 53834 using a Tensorapid 3 measuring instrument.

### Inventive Example 1

A continuous, vertically stirred gas phase reactor having a nominal capacity of 12.5 m³ was charged with 300 g/h of a supported metallocene catalyst prepared according to Example 9.1 of WO 00/05277. The reactor was operated at 24 bar and 67° C. Propylene was added at a rate of 2.1 t/h to maintain the pressure. 400 g of triisobutyl aluminum/t of propylene were added as cocatalyst. The product was discharged by brief, pulsed decompression via a dip tube. After entrained monomer had been separated off and the reactor powder obtained had been rinsed with 20 standard m³/t of nitrogen, the polymer powder was transferred into a receiver vessel. The melt flow rate was determined at 5.5 g/10 min. From the receiver vessel the powder was metered by a continuous weighing means into the hopper of an extruder (ZSK 130 from Werner & Pfleiderer). The propylene polymers were degraded by injecting 600 g of a 32.5 percent solution of an organic peroxide

(2,5-dimethyl-2,5-di-tert-butylperoxyhexane, Trigonox 101, Akzo-Nobel) in heptane per metric ton of polypropylene into the third extruder housing. The extrudate was chopped into pellets by a Werner & Pfleiderer UG 200 underwater pelletizer and the pellets were separated from the water using a centrifugal drier (from Gala). The pellets obtained had an average melt flow rate of 12 g/10 min and a PDI of 1.7.

The pellets were spun into fiber on an Oxford yarn spin-draw-winding machine from Rieter, Winterthur, Switzerland. The equipment included an unheated feed roller and a 3^{rd} godet pair (duo 3). The extruder was fitted with a 3 zone screw (D=50 mm; L=24 D) with RTM mixer. The compression ratio was 3.1. The internal diameter of the melt line narrowed conically and had 3 static mixing elements from Sulzer. A Mahr spinning pump providing 2×3.6 cm³/revolution was used. The pourer plate was 80 mm in diameter and had 12 capillaries of d=0.45 and 1=0.9 mm. The filter pack used was a 4-fold sieve (d32 68 mm; 21000/9000/625/64 M/cm²) packed with 260 g of 350-500 micrometer steel powder between the sieves. The spin finish used was Stantex S 6024 from Cognis, and it was applied as a 10% by weight emulsion at 0.8 to 1% on weight of fiber.

The operating parameters were:

| | |
|---|---|
| Zone 1 temperature: | 230° C. |
| Zone 2 temperature: | 235° C. |
| Zone 3 temperature: | 235° C. |
| Zone 4 temperature: | 240° C. |
| Diphyl temperature: | 240° C. |
| Extruder pressure: | 100 bar |
| As-spun 12-filament linear density: | 80 dtex |
| Quench air temperature: | 20° C. |
| Air humidity: | 75% |
| Quench air velocity: | 0.4 m/s |
| Distance between oiler and spinneret: | 140 cm |
| Distance between oiler and sieve: | 26 cm |
| Mono 1 speed: | 3020 m/min |
| Mono 1 wraps: | 3 |
| Duo 3 speed: | 3030 m/min |
| Duo 3 wraps: | 5 |
| Winder speed: | 3000 m/min |
| Traversing means: | Grooved rolls |
| Yarn tension decrease: | 1000 |
| V+packing: | 120 m/min |
| V+winder: | 100 m/min |
| V+tube: | 1% |
| Crossing angle 1-4: | 14% |
| Yarn tension above winder: | 5,2 cN |
| Yarn tension above mono 1: | 9,0 cN |

The values measured on the fibers obtained are reproduced below in Table 1.

### Comparative Example A

Inventive Example 1 was repeated except that an additional 4 g of hydrogen/t of propylene were metered into the reactor. The reactor powder had a melt flow rate of 12 g/10 min. No peroxide was metered into the extruder. The pellets obtained had an average melt flow rate of 12 g/10 min and a PDI of 1.9.

The values measured on the fibers obtained are reproduced below in Table 1.

### Inventive Example 2

Inventive Example 1 was repeated except that 1.2 kg of a 32.5 percent solution of an organic peroxide (Trigonox 101, Akzo-Nobel) in heptane were metered into the 3^{rd} extruder housing per metric ton of polypropylene. The pellets obtained had an average melt flow rate of 18 g/10 min and a PDI of 1.6.

The values measured on the fibers obtained are reproduced below in Table 1.

### Comparative Example B

Inventive Example 1 was repeated except that an additional 12 g of hydrogen/t of propylene were metered into the reactor. The reactor powder had a melt flow rate of 18 g/10 min. No peroxide was metered into the extruder. The pellets obtained had an average melt flow rate of 18 g/10 min and a PDI of 1.8.

The values measured on the fibers obtained are reproduced below in Table 1.

### Inventive Example 3

Inventive Example 1 was repeated except that 1.9 kg of a 32.5 percent solution of an organic peroxide (Trigonox 101, Akzo-Nobel) in heptane were metered into the 3^{rd} extruder housing per metric ton of polypropylene. The pellets obtained had an average melt flow rate of 30 g/10 min and a PDI of 1.7.

The values measured on the fibers obtained are reproduced below in Table 1.

### Comparative Example C

Inventive Example 1 was repeated except that an additional 25 g of hydrogen/t of propylene were metered into the reactor. The reactor powder had a melt flow rate of 30 g/10 min. No peroxide was metered into the extruder. The pellets obtained had an average melt flow rate of 30 g/10 min and a PDI of 1.6.

The values measured on the fibers obtained are reproduced below in Table 1.

TABLE 1

| | MFR | | Tenacity | Extension |
|---|---|---|---|---|
| Example | [g/10 min] | PDI | [cN/dtex] | [%] |
| Inventive 1 | 12 | 1.7 | 3.7 | 156 |
| Comparative A | 12 | 1.9 | 3.2 | 182 |
| Inventive 2 | 18 | 1.6 | 3.6 | 114 |
| Comparative B | 18 | 1.8 | 3.1 | 186 |
| Inventive 3 | 30 | 1.7 | 3.2 | 120 |
| Comparative C | 30 | 1.6 | 2.6 | 182 |

The data reported in Table 1 show that the polymers of Inventive Examples 1-3 have the same flowability as the corresponding Comparative Examples A-C and the width of the molar mass distribution does not differ within the margin of error. Yet, the polymers of the invention provide approximately 15-16% better filament tenacities. Since the error for a tenacity determination is only ±1%, this amounts to a significant increase in the tenacity.

We claim:

1. A process for producing from propylene, ethylene and/or C₄-C₁₈-alk-1-enes a fiber grade propylene polymer in which not less than 90 mol % of the units derived from monomers are derived from propylene and which has a polydispersity index PDI of not more than 2.2, where PDI is M_{W}/M_{N}, where M_{W} is the weight average molar mass and MN is the number average molar mass and both are determined by gel permeation chromatography (GPC) at 145° C. in 1,2,4-trichlorobenzene, by polymerizing the monomers by means of a metallocene catalyst system, which comprises subsequently degrading said propylene polymer peroxidically or thermally.

2. A process as claimed in claim 1, wherein said propylene polymer is a homopolymer of propylene.

3. A process as claimed in claim 1 or 2, wherein said propylene polymer is degraded peroxidically at extruder temperatures in the range from 180 to 280° C. and pressures from 0 to 200 bar.

4. A process as claimed in any of claims 1-3, wherein the metallocene-catalyzed polymerization of the monomers is carried out in the gas phase.

5. A propylene polymer obtainable by a process as claimed in any of claims 1-4.

6. A process for producing different propylene polymers as set forth in claim 5 which have different MFR melt flow rates, which comprises controlling the metallocene-catalyzed polymerization of the monomers in such a way that the polymerization provides substantially always the same melt flow rate and the differences in the melt flow rates of the degraded products are obtained by adding different amounts of peroxide.

7. A method of using a propylene polymer as claimed in claim 5 for producing fiber.

8. Fiber, film or a shaped article comprising the propylene polymer of claim 5.
